(19) United States
(12) Patent Application Publication
(10) Pub. No.: US 2009/0132585 A1
(43) Pub. Date: May 21, 2009

(54) INSTRUCTIONAL LESSON CUSTOMIZATION VIA MULTI-MEDIA DATA ACQUISITION AND DESTRUCTIVE FILE MERGING

(76) Inventor: JAMES TANIS, New York, NY (US)

Correspondence Address: OSTRAGER CHONG FLAHERTY & BROITMAN PC, 570 LEXINGTON AVENUE, FLOOR 17, NEW YORK, NY, 10022-6894, US

(21) Appl. No.: 11/942,324

(22) Filed: Nov. 19, 2007

(51) Int. Cl. G06F 7/16

(52) U.S. Cl. 707/104.1

(57) ABSTRACT

A method and system for creating user-customized multimedia-based instructional lessons enables a user to select desired instructional lesson segments retrieved or generated as media files from a storage medium, and integrate the media files for the selected lesson segments into an instructional lesson media file. For creating a customized language learning lesson, a large amount of language phrase segments may be stored in media files in a database. A user may browse the phrase segments and select what is of interest then order them into a preferred lesson sequence that is converted by destructively merging the media files into a single output media file. The output media file becomes a customized lesson created by the user. The user's customized lesson may be burned to a CD, downloaded to a media player, or used in a similar fashion.

### FIELD OF INVENTION

This invention relates to computer-implemented learning methods and, more specifically, to instructional lessons in the field of language learning.

### BACKGROUND

Learning a new language is a major undertaking by any person. It is typically a long and difficult process. There are many rules that affect the language such as sentence structure and gender association. However the most fundamental and often times dreaded part of language learning is vocabulary building. It is understood that proper language structure, syntax and grammar are somewhat required when speaking any language. However, a weak vocabulary makes it increasingly difficult to communicate. Many times we communicate with people who are not native speakers of our language. The success of this communication is usually not the in depth knowledge of language syntax. Rather, it is the possession of an adequate vocabulary to get the point across. Often times it is one or two key words that are required to communicate a message. The native speaker can still understand the foreign speaker, even with a lack of perfect sentence structure.

There are many roads to take when learning a new language. Among these is traditional classroom learning, listening to pre-recorded lessons on audio CD, and there are also many software packages and websites available online. All have their advantages and disadvantages with regard to vocabulary building. Many teaching methods are broad in nature and struggle to efficiently expand a person's vocabulary. These prior methods may include many other topics in addition to vocabulary building. Prior teaching methods attempt to bring a student to conversational levels with perfect speaking form. Yet, if a person is simply interested in vocabulary building, or learning a few simple phrases, these methods are largely inefficient.

### SUMMARY OF INVENTION

A method and system for creating user-customized multimedia-based instructional lessons enables a user to select desired instructional lesson segments retrieved or generated as media files from a storage medium, and integrate the media files for the selected lesson segments into an instructional lesson media file. For creating a customized language learning lesson, a large amount of language phrase segments may be stored in media files in a database. Each phrase segment is stored as a media file. The database may contain media files in a plurality of languages. A user may browse the phrase segments and select what is of interest to them. The user can order the selected phrase segments into a preferred lesson sequence. The user-customized arrangement may then be converted to a lesson output by destructively merging the media files for the ordered phrase segments into a single output media file. The single output media file may contain the metadata for the individual media files, as arranged in the user's preferred sequence. In this manner, the output media file becomes a customized lesson created by the user. The user's customized lesson may be burned to a CD, downloaded to a media player, or used in a similar fashion.

Rather than tracking several smaller files, a larger output file is created containing the same information in a unified file. The source media library may be accessed as a remote database and used to create a customized lesson that is delivered to the user's system. This method drastically reduces the amount of media files on the user's system while still providing the same information. With a reduced number of media files on the user's system, file clutter is reduced and system performance is preserved.

The user-customized lesson method provides several advantages over prior learning methods. For example, a user can focus on a specific area of vocabulary building. By creating a user-customized lesson using the database driven system, the user can select certain vocabulary phrases that are useful. Further, the user may sort the individual phrases into a preferred sequence that suits their requirements. This allows the user to learn exactly what they want, when they want to. It eliminates the burden and wasted time of material that is not needed. The invention method facilitates and adds convenience to language learning on audio CD. Since the user can customize their own lesson, hunting for lesson segments of interest or distractions while fast-forwarding or rewinding can be avoided. The user-selected phrases have been arranged into a preferred sequence and merged into a customized lesson. By creating user-customized lessons using the database driven system, the user can create a lesson made up solely of the phrases they are interested in learning. This will allow the user to focus on specific vocabulary until it is placed into their long-term memory. Another advantage of the user-customized lesson method is the ability to print transcripts of the customized media lesson. The text metadata of the individual phrase segments are stored in a merged file data log, and the user can print a text version of all phrases in the lesson. This will allow the user to read along as they are listening to the media. This is especially helpful in increasing reading and writing skills. It creates an association between the spoken word and written word.

Further objects and advantages of my invention will become apparent from a consideration of the drawings and ensuing description.

### BRIEF DESCRIPTION OF DRAWINGS

FIG. 1 is a flowchart of a preferred embodiment for processing of a user-customized multimedia-based lesson.

FIG. 2 is a graphical representation of an exemplary user-customized language lesson sequence containing Spanish media clips.

FIG. 3 is a graphical representation of an exemplary user-customized language lesson sequence containing Spanish and English media clips.

FIG. 4 is a graphical representation of an exemplary user-customized language lesson sequence containing repeated media clips.

FIG. 5 is a flowchart showing the exemplary actions of a practical system for creating user-customized multimedia based language learning lessons.

FIG. 5A is a flowchart of the specific sequence for creating an output media file from the media files for selected phrase segments.

FIG. 5B is a flowchart of the specific sequence for an alternate method of creating an output audio file using text-to-speech generators in lieu of a database.

FIG. 6 is an exemplary screen layout for previewing the media database.

FIG. 7 is an exemplary layout of a blank lesson customization screen.

FIG. 8 is an exemplary screen layout of an active lesson customization process.

FIG. 9 is an exemplary layout of a user-customized lesson preview screen.

FIG. 10 is an exemplary layout of a detailed user-customized lesson preview screen.

FIGS. 11A, 11B, 11C and 11D show exemplary methods of deployment for the customized lesson method.

### DETAILED DESCRIPTION

A detailed description of preferred embodiments of the invention is provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

For the purposes of this disclosure, the following shall apply: (1) “media” and “audio” may be used interchangeably and shall be defined as any means for communication, including but not limited to, audio, video, still images, written text, and any other means of communication or information distribution; (2) “phrase” or “word” may be used interchangeably and shall mean phrase, word, number or sentence; (3) “graphical user interface”, “GUI” or “interface” shall mean any graphics based human-computer interface method that is part of a website or software package.

The present invention solves a number of problems that exist with conventional language-learning lessons, tapes and/or CDs. In a classroom setting, an instructor typically follows a prepared lesson agenda. This may include many topics other than vocabulary building. Additionally, the student must follow along at the instructor's pace. This pace may be to too slow or too fast, depending on the student's skill level. In one scenario, a businessman may be taking weekly night classes. He is learning Spanish because several of his clients speak Spanish. The classes tend to be intensive due to the nature of weekly night classes. The instructor is covering lots of material in a small amount of time. The businessman's primary goal is to learn a few phrases that would be useful to him in his field. Perhaps he is simply interested in a few polite greetings. However, due to the breadth of material in the classroom setting, he is overwhelmed and frustrated because his primary goals are not being met in a timely manner.

Conventional CDs have pre-packaged lesson plans similar to classroom learning. While a user can skip from track to track, they are still bound by the lesson of the current track. Let's say a particular audio lesson is six minutes long. A user may only be interested in a ten second portion of audio in the middle of the lesson. This may be the location of a preferred word translation. In this case, they are generally forced to listen to the preceding audio. For example, if a user simply wants to know how to say “Good Morning”, they may have to listen to an entire audio lesson on greetings. Listeners may try to fast-forward through the unwanted material. However, this task requires additional time and possesses little accuracy in finding the relevant portion. There are also potential risks to public safety. Consider a person driving while searching for a phrase. The division of attention and loss of one hand to fast-forward the CD may prove to be hazardous while driving. If the driver could customize his or her own lesson, fast-forwarding may not be an issue.

Vocabulary building is achieved through memorization which is facilitated through verbal repetition. In classroom learning, as well as audio CDs, new vocabulary is introduced quickly and practiced briefly before moving on to new material. Typically, not enough time is devoted to fully learning a new word or phrase. It would be desirable to create customized lessons in which a user can focus solely on desired phrases to be learned. This would allow the user to focus on specific vocabulary until it is placed into their long-term memory.

Foreign phrase translations are available online, and many sites offer foreign dictionaries and phrasebooks. The more advanced sites also provide an option to play the audio of a foreign word. However, a major shortcoming is the lack of ability to hear multiple phrases in a desired sequence and to organize the audio fragments into a useful lesson. While most sites give you an option to download audio, the problem lies in tracking and playing the audio fragments after they are downloaded. If the user desires large quantities of phrase files, there will be large quantities of tiny files on their computer. This creates two problems. The first problem is file organization. With thousands of files on a user's system, from a user's perspective, it will become increasingly difficult to locate phrase media. The second problem is a reduction in system performance. With thousands of media files on a user's system, the media seek and retrieval times are increased. This is because a processor must sort though the many individual media files to locate the desired file. Typically media files require more system resources than most other files, thus performance reduction is more apparent. A system containing one hundred media clips, each one-minute long will experience a performance reduction compared to the same system containing one media clip, one hundred minutes long.

In accordance with the present invention, a method for user-customized lesson creation allows a user to create their own customized multimedia lesson. From segment media files retrieved or generated from a storage medium, the user may browse and select pertinent segment media files then arrange the pertinent segments into a preferred lesson sequence. The arranged media files may then be destructively merged into a single, larger lesson media file as an output. This customized lesson media file may then be previewed online, pushed to a mobile device, downloaded to a workstation or portable media player.

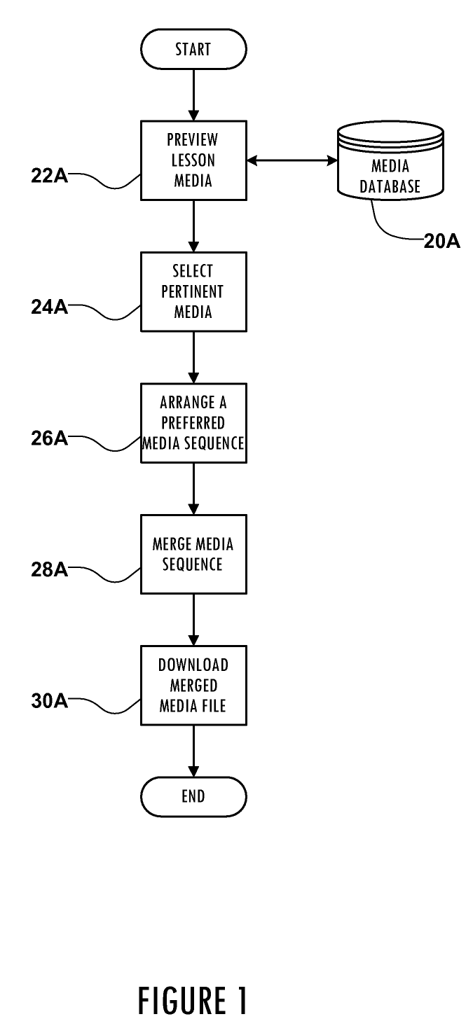

FIG. 1 is a flow chart depicting a preferred embodiment for processing of a user-customized multimedia-based lesson. A media database 20A is provided with a large quantity of audio phrases. Each phrase may be its own media file. In step 22A, a user may browse the available media contained in the database 20A. In step 24A a user may select media from the database 20A that is pertinent to their learning requirements. In step 26A a user may arrange their pertinent media clips into a preferred sequence. This may include specifying the order of clip appearance as well as the number of times a clip appears. After arranging the audio clips into a preferred lesson sequence, the user may merge the clips into a single, larger file (Step 28A). Step 28A is a destructive file merging process. Destructive file merging pertains to taking two or more media files and joining them to create one larger media file. After its creation, the larger media file is independent of the source media files. The process is irreversible, thus being destructive. Methods for saving and retrieving source media clip information of the merged media file are discussed later. Destructive file merging may be achieved using any readily available media merging techniques. In step 30A a user may download the resultant merged media file. This action may download the file to a computer, portable media player, cell phone, blank CD or be used in any other device in which a user may preview the lesson.

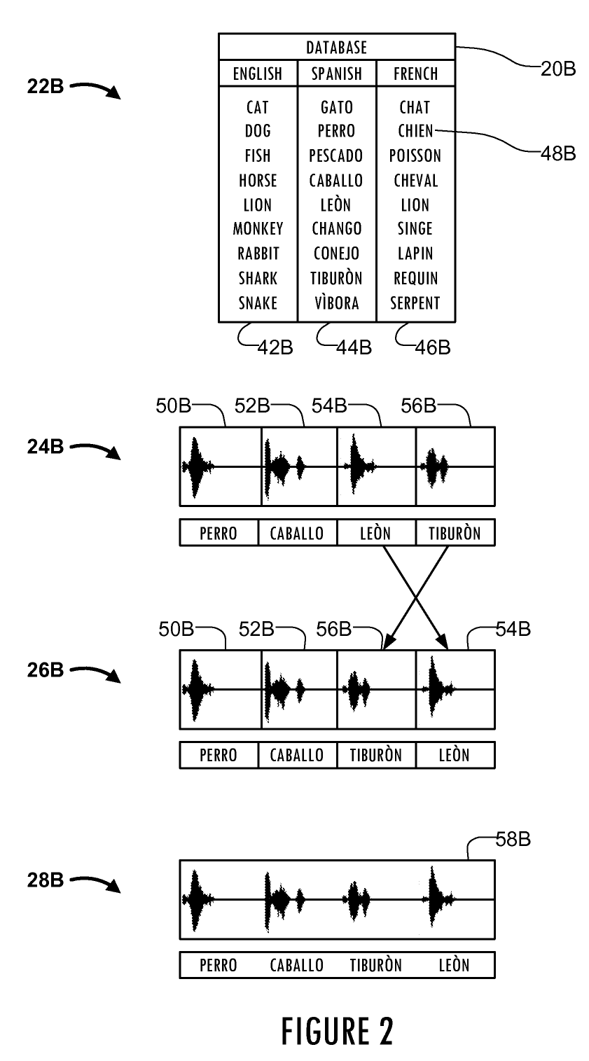

FIG. 2 is graphical representation of an exemplary lesson sequence created with the flow of FIG. 1. The media within the database 20B may be organized by language 42B, 44B, and 46B. Each language may contain a plurality of audio files. Accordingly, a row 48B may represent a single phrase presented in multiple languages. The user may preview the database 20B to locate any pertinent phrases (step 22B). At step 24B, the user has selected four media files 50B, 52B, 54B, 56B from the Spanish column 44B of the database 20B. All waveforms shown are for illustrative purposes and may not be the actual waveforms of their respective phrases.

In this example the user wants to learn how to say dog 50B, horse 52B, lion 54B and shark 56B in Spanish. However, in Step 26B, the user prefers the sequence of clips to be dog 50B, horse 52B, shark 56B, lion 54B. Phase rearrangement may be achieved using a variety of GUI systems. This may include drag-and-drop technology or a static icon clicking system.

At step 26B, the individual audio files 50B, 52B, 56B, 54B are still a compilation of individual audio clips. In step 28B the individual media files 50B, 52B, 56B, 54B are destructively merged into a single media file 58B. The destructive merging process may use copies of media from the database 20B, thus the database 20B remains intact.

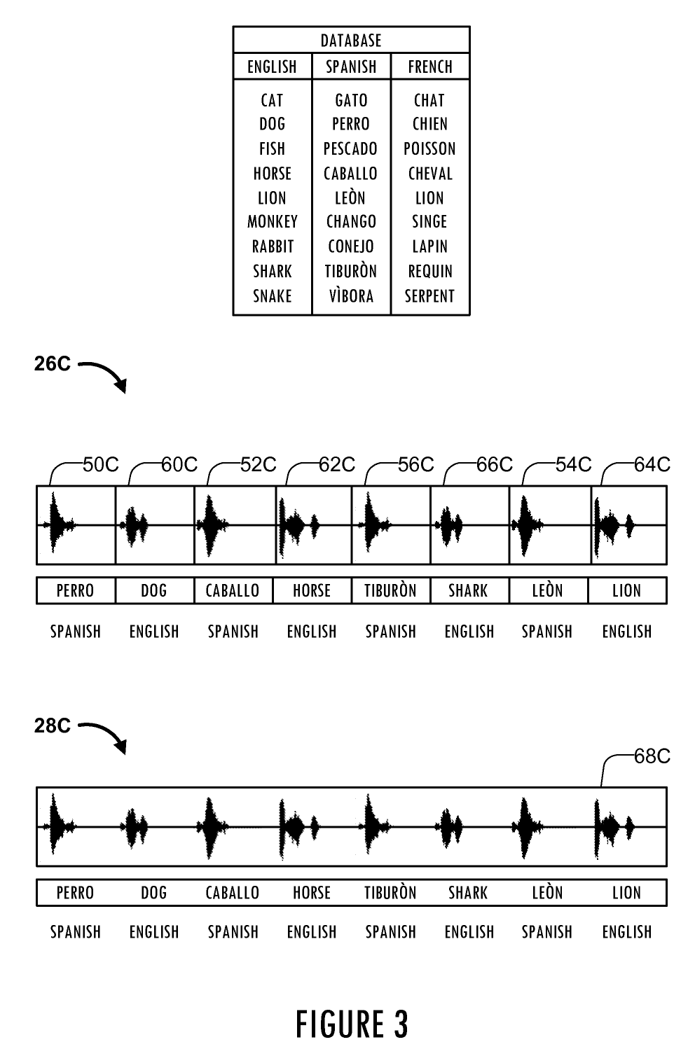

FIG. 3 is a graphical representation of an exemplary lesson sequence in which multiple languages are included in the user's customized lesson. More specifically, audio clips of the user's native language follow the foreign audio clips. In this example, the native language is English and the foreign language is Spanish.

The user-customized lesson depicted in FIG. 2 may be useless of you are completely unfamiliar with the foreign words of the lesson. In step 26C of FIG. 3, the user has arranged the same lesson media of FIG. 2 with the addition of native language audio clips. The Spanish media files 50C, 52C, 56C, 54C are followed by their respective English media files 60C, 62C, 66C, 64C. This will deliver audio containing a translation of each foreign word. This may be helpful if the listener has no idea what the foreign words mean. At this point, step 28C may be executed to create a single merged media file 68C. When the user listens to the new merged media file 68C, they will hear:
“Perro . . . Dog . . . Caballo . . . Horse . . . Tiburón . . . Shark . . . León . . . Lion”.

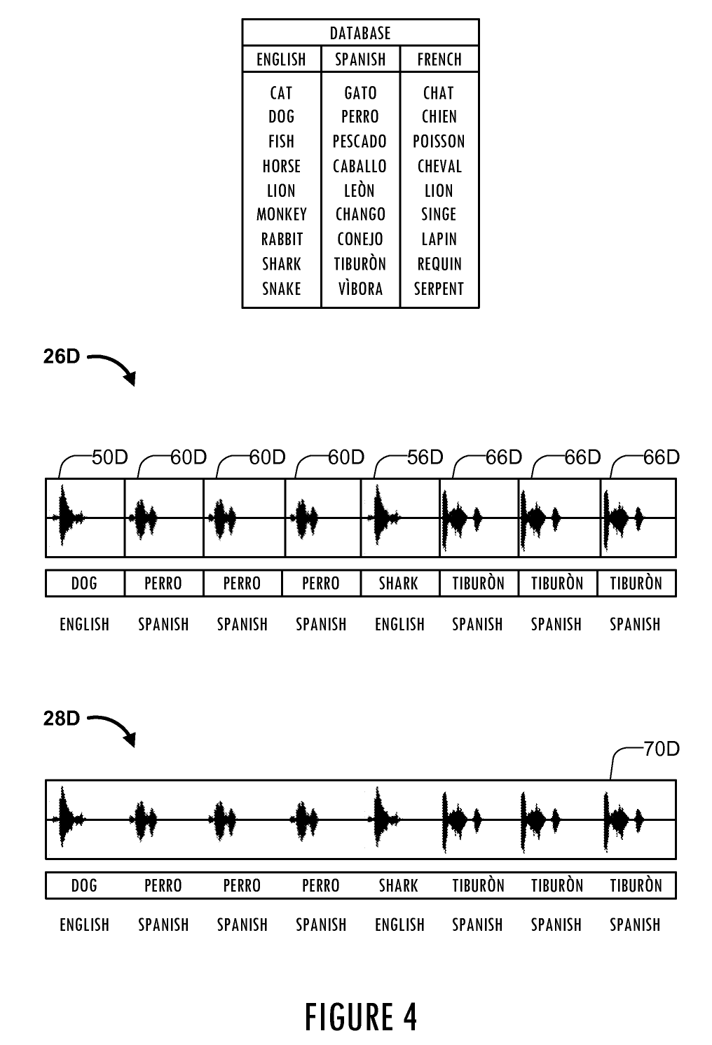

FIG. 4 is another exemplary method of creating a user-customized lesson. In FIG. 4, the user is simply interested in learning how to say Dog and Shark in Spanish. Perhaps they have already memorized the animals in the previous lessons. Yet they are having trouble with Dog and Monkey. One method of foreign vocabulary memorization is through simple repetition. In step 26D of FIG. 4, the user prefers to start with their native language and repeat the foreign word three times. Therefore, the sequence of media in step 26D is media file 50D, 60D, 60D, 60D, 56D, 66D, 66D, 66D. After creating a merged media file 70D in step 28D the user will hear:
“Dog . . . Perro . . . Perro . . . Perro . . . Shark . . . Tiburón . . . Tiburón . . . Tiburón”.

While the example in FIG. 4 shows the phrase translations repeated three times, this arrangement may vary widely in repetition quantity.

In the following description, an exemplary method and system is designed for more practical language learning through the use of tailored graphical user interfaces (GUI) and suggested screen flows. These described methods may allow a user to easily move from the media database to the final merged output file. Although many subsystems are described, such as graphical user interfaces (GUI) and screen flow, these methods are not intended to limit the possible delivery methods of the preferred and alternate embodiments.

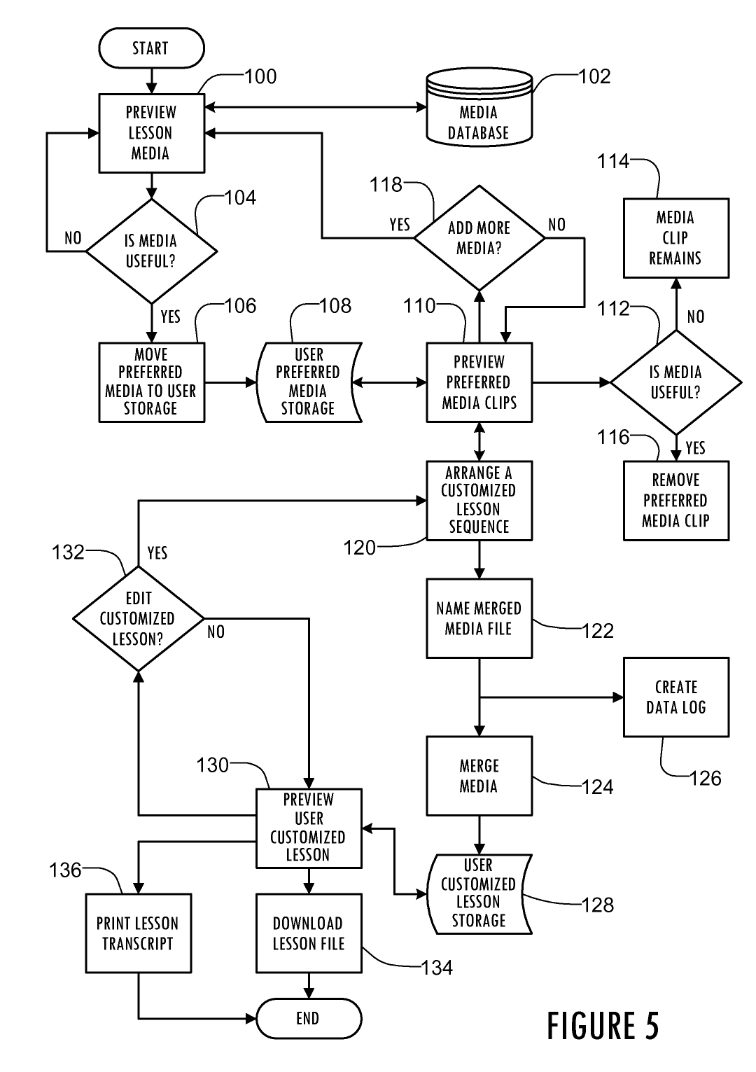

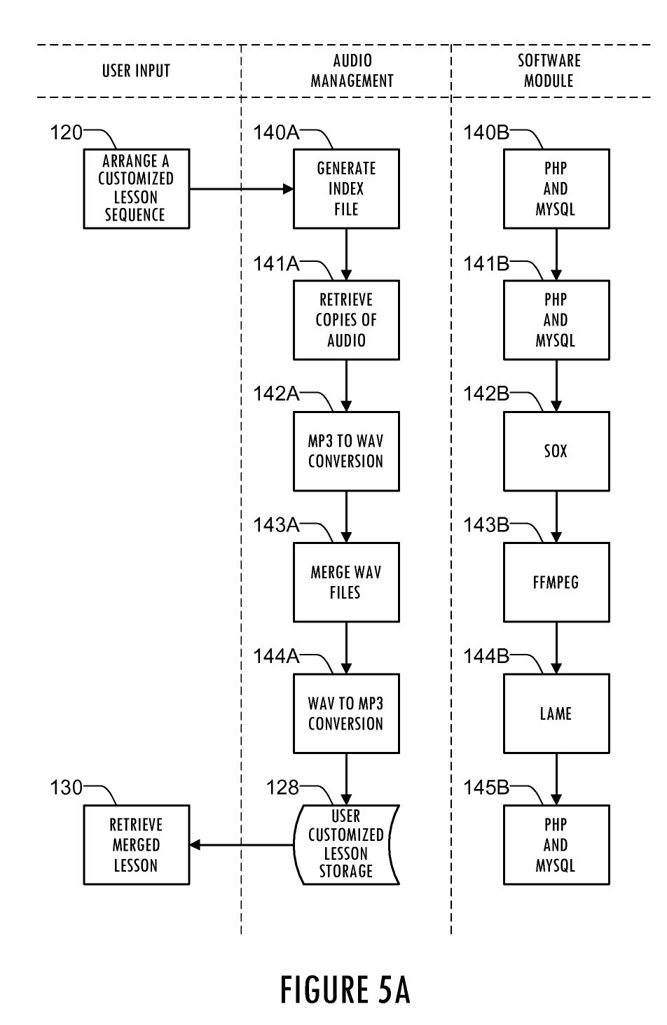

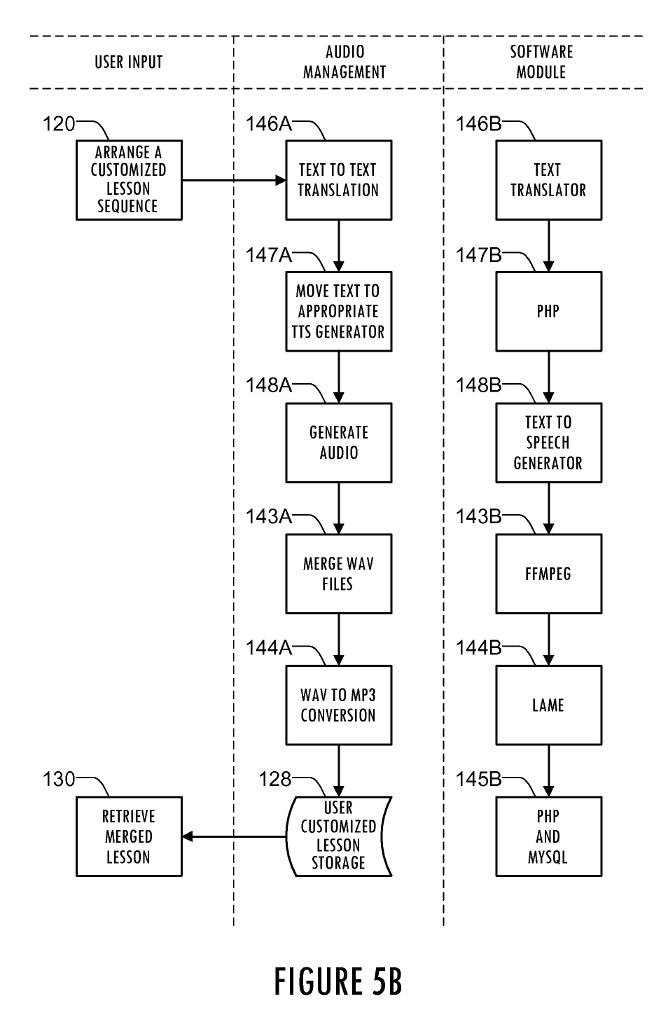

FIG. 5 is a flow chart of an exemplary model of a more practical lesson customization system that may be used in a website or proprietary software package. In step 100 a user may review the contents of a media database 102. The database 102 may contain large quantities of media pertaining to the lesson theme. For the purposes of this disclosure, the lesson theme is language learning. Thus, the database 102 may contain a plurality of audio phrases in a plurality of languages. Each phrase may be its own media file. In act 104 the user will decide if any of the media in the database 102 is useful. If the user decides certain media is useful, step 106 may move a copy of the preferred media from the database 102 to the User Preferred Media Storage 108. Alternatively, step 106 may keep a database location identifier in the User Preferred Media Storage 108 in lieu of physically copying the media file from the database 102. If the currently viewed media in step 100 is not useful, act 104 shall keep the user in step 100 until useful media is found in the database 102.

Once media is present in the User Preferred Media Storage 108, the user may preview this media (step 110). Act 112 may allow the user to reevaluate if the media is still relevant to their lesson requirements. If the media is relevant, it remains in the User Preferred Media Storage 108 (step 114). If the user decides the media is no longer required, it may be removed from the user preferred media storage 108 (step 116). If additional media clips are desired, act 118 allows the user to return to step 100 and review the contents of the primary media database 102.

Step 120 allows the user to take media files in the User Preferred Media Storage 108 and arrange them into a Customized Lesson Sequence. As described in FIG. 2, 3 and 4, this may contain media clips in several languages, arranged in any sequence, with media clips appearing multiple times. When customizing a lesson sequence, the flow between steps 120 and 110 may be bidirectional to allow repeated data acquisition from the user preferred media storage 108.

Step 122 allows the user to name the resultant merged media file. An exemplary file name maybe:
Spanish_numbers1-10.mp3

This is an arbitrary name created by the user. Step 122 is required as the process may be repeated several times. Each time the process is run, a unique file name must be given to each file. While the mp3 file extension is used in the example, many audio file formats may be used in the method.

In step 124 the user may merge the individual media files assembled and arranged in the user-customized lesson sequence 120. This is a destructive merging process in which the individual media properties are lost and replaced with a single, larger file, containing all the media information. Step 124 is a preferred step as handling one large media file containing all required media has several advantages over handling many smaller files containing equivalent media.

One advantage of destructive media merging is that file management on the user's system is simplified. A merged file may contain dozens of individual media files. Additionally, this process may be repeated a number of times. In this case, a user may have seven or eight merged files on their system. If each merged file contained around fifty media files, the user would have an equivalent of about eight hundred media files on their system. With destructive file merging, file clutter is reduced and file organization is improved, while all the required media is still present.

Another advantage to the destructive file merging of step 124 is preservation of system performance. A hard drive containing hundreds or thousands of media files will experience a reduction in performance. This is due to the system's need to index and sort through all of the media files as it locates the file requested by the user. However, if the hard drive contained only a handful of merged media files that possessed all the same media, system performance will be preserved. This is a result of fewer files on the hard drive and thus, a reduction in the system's media access time. The principle of these performance characteristics is file quantity, not file size. A system containing one hundred media clips, each one-minute long will experience a performance reduction compared to the same system containing one media clip, one hundred minutes long.

Prior to the individual media clips being rendered into a single media file, a data log 126 may be created. The data log 126 may contain a list of source media files used to create the resultant merged file. This may contain database 102 identifiers as well as metadata associated with the individual media files. Metadata may include, media file size (bytes), media file length (seconds), filename, folder location, copyright information, textual description and phrase text, etc. The data log 126 will be referenced in further steps described below.

After a merged file has been created it may be moved to a user-customized lesson storage location 128. Step 130 allows the user to preview the contents of the user-customized lesson storage 128. If the user decides a merged file in the user-custom lesson storage 128 needs to be modified, act 132 may move the contents of the merged media file back to step 120. While step 124 performed a destructive merging action, the contents of the merged file may be retrieved from the data log 126. Thus, act 132 may access the data log 126, with respect to the merged media file being modified. Information retrieved from the data log 126 may be used to recreate the merged media file and place it back into step 120. At this point the user may modify the customized lesson sequence by deleting media files, rearranging media files, or adding media files from the User Preferred Media Storage 108.

Step 134 allows the user to download a merged media file from the user-customized lesson storage 128. Downloading a media file may take several forms. A user may download a file from the internet to their workstation. This may then be transferred to a portable media player. Media may also be pushed from a global network to a PDA or mobile telephone. Alternatively, self-contained software systems may store the merged media file on the local system or move it as described above.

Step 136 allows the user to print a transcript of their customized lessons. While step 124 performed destructive merging of individual media clips, the data log 126 may contain the individual file information (metadata) of the merged audio clips. The metadata may be used to create a transcript of the merged audio file. This may allow the user to read along with the audio. This may be useful to the user as reading a transcript while previewing media creates a relationship between the spoken words and their respective printed words. The transcript may allow the user to become familiar with the foreign alphabet as well as improve their reading and writing skills.

FIG. 5A is a flowchart further describing the actions of steps 120 and 124 of FIG. 5. Column 1 represents the User Input actions input by the user. Column 2 represents the Audio Management flow to achieve the desired media output. Column 3 represents the Software Module tools that may be used at a specific point in the data flow. The data flow sequences are described with respect to a user-customized lesson system using audio media stored in MP3 format.

When a user arranges a customized lesson sequence 120, a user-customized lesson system may generate an index file 140A. This may be achieved using PHP database code and MySQL (Module 140B). Based on the index file 140A, step 141A may then move physical copies of individual audio files from the database 102 to a temporary storage folder (Module 141B). Audio stored on the database 102 may be in MP3 format to preserve storage space. Step 142A may convert MP3 audio to WAV format using the SOX software module 142B. SOX is open source software that may be used to convert between many different audio formats. Step 142A may be necessary because a file merging process 143A may require all audio to be in WAV format. Step 143A merges audio files end to end in a sequence defined by the index file 140A. File merging 143A may be achieved using an FFMPEG software module 143B. FFMPEG is open source software that can record, convert, and destructively merge audio and video media. After the WAV files have been destructively merged, a second file conversion may be performed to convert back to MP3 format. This may be desirable in the interest of file space. WAV to MP3 conversion (Step 144A) may be achieved using LAME open source software (Module 144B). LAME is an MP3 encoding engine that can convert WAV audio to MP3. Additionally, a user-customized lesson system may use the LAME encoder to include audio metadata in the output file for user convenience. After the customized audio lesson has been converted to MP3 it may be moved to the User Customized Lesson Storage 128 using PHP code and MySQL (Module 145B). Using a graphical user interface a user may preview their customized audio lessons (Step 130) as described in FIG. 5.

The preceding system depicted in FIG. 5A and described above was for a user-customized lesson system using audio media stored in MP3 format. It is to be understood that the flow of FIG. 5A may be altered if a developer elects to use alternative audio formats. Further, the system described above can be easily modified to accommodate video media. FFMPEG (Module 143B) is already capable of performing destructive video merging. Through minor PHP code adjustments and replacing audio conversion processes with video conversion processes, on skilled in the art may create a user-customized lesson system using video media.

FIG. 5B is a flowchart showing an alternative to the database 102 when creating a user-customized language lesson. As an alternate method, a text-to-speech (TTS) generator may be used in lieu of the multi-lingual audio database 102. Rather than retrieving individual audio files from the database 102, multi-lingual audio clips may be generated using TTS software as part of the output process. FIG. 5B describes the actions of steps 120 and 124 of FIG. 5 with regard to the alternate TTS method.

A user may arrange a customized lesson sequence 120 by entering text on a GUI. The GUI may provide the user an option to specify multiple language translations of the entered text. Step 146A may translate the text entered by the user to the appropriate foreign text. A text translation software module 146B may be obtained from many sources, such as SYSTRAN Software Inc.

Once the text is translated, step 147A may move the foreign text strings to the appropriate text-to-speech (TTS) generators. Text-to-speech generators typically operate in one language. Therefore, each language may require its own text-to-speech generator. Text routing may be done using PHP (Module 147B) or similar scripting language.

Step 148A may take the translated text created in step 146A and output an audio file containing the audible representation of the text. This may be done using text-to-speech generators (Module 148B). The text-to-speech generator 148B may be obtained from many sources, such as AT&T Natural Voices™. The audio generators may be configured to output WAV audio, thus eliminating the need to convert from MP3 audio to WAV audio (Step 142A, FIG. 5A).

After the individual audio clips are generated 148A, the system may be assemble and arrange the audio clips per the customized lesson sequence 120. The generated audio files may then be destructively merged 143A using FFMPEG (Module 143B). As mentioned in FIG. 5A, the merged files may be converted to MP3 144A using the LAME encoder (Module 144B). Final merged MP3 audio may be moved to the user-customized lesson storage 128 using PHP and MySQL (Module 145B). Using a GUI, a user may preview their customized audio lessons (Step 130) as described in FIG. 5.

The TTS alternative may be advantageous as the database for source audio files is eliminated. Yet, this may not be desirable as the audio quality and accuracy of text-to-speech generators is typically poor and available in limited languages. However, as text-to-speech generator technology improves, this may be a suitable alternative.

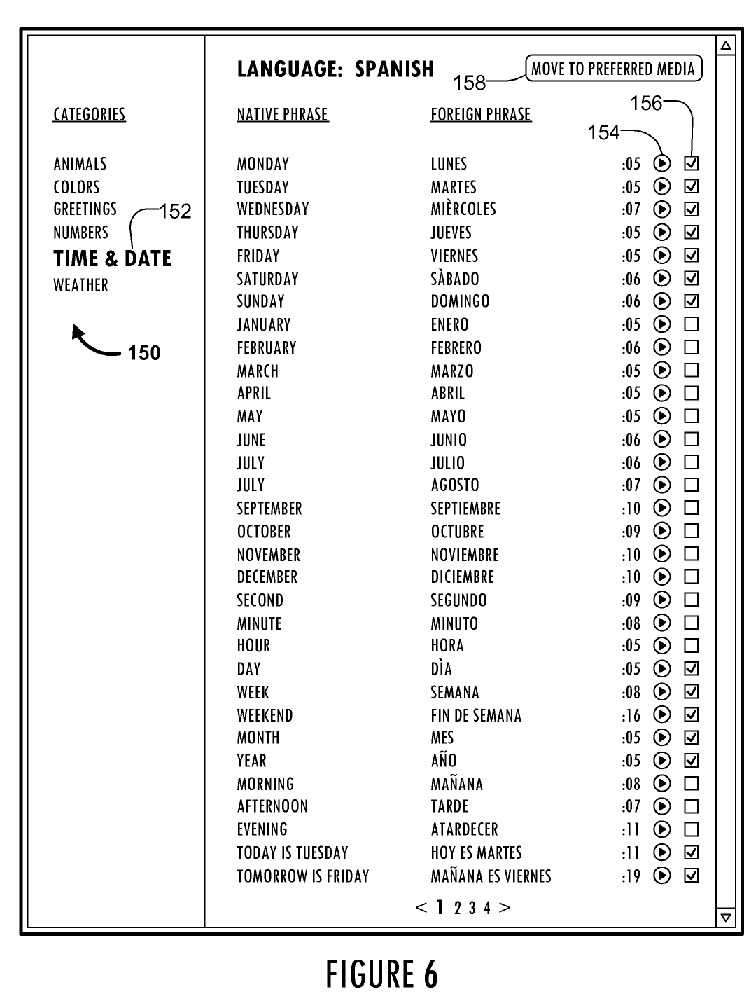

FIG. 6 is an exemplary layout of a graphical user interface (GUI) representing steps 100 and 106 of FIG. 5. More specifically, FIG. 6 is a GUI for previewing media in the database 102. For this example, the user is a native English speaker seeking to learn Spanish.

On the left side of FIG. 6 is a category list 150. This may be used to help locate media in the database 102. In this example, the user has chosen a Time & Date category 152. This is noted with the screen text becoming larger and bolder than the other categories. Upon selecting Time & Date 152, all phrase media contained in the database 102 relating to Time & Date may appear on the screen. This is essentially step 100 of FIG. 5—Preview Lesson Media.

When previewing media in the database 102, the user may view the written translations as well as listen to audio clips. A “play” button 154 is provided to access the audio content of a particular phrase. The play button 154 may open a media player that is internal or external to the method.

While previewing the media available on the database 102, the user may decide some phrases are more relevant than others. To allow easier access to preferred phrases in the future, the user may move these phrases to a Preferred Media Storage location. In this example the user has chosen to move fourteen pertinent phrases. Selecting a check box 156 next to the pertinent phrase may denote this. After the user has selected all phrases relevant to their lesson requirements, a button labeled “Move to Preferred Media” 158 may be clicked to initiate the move.

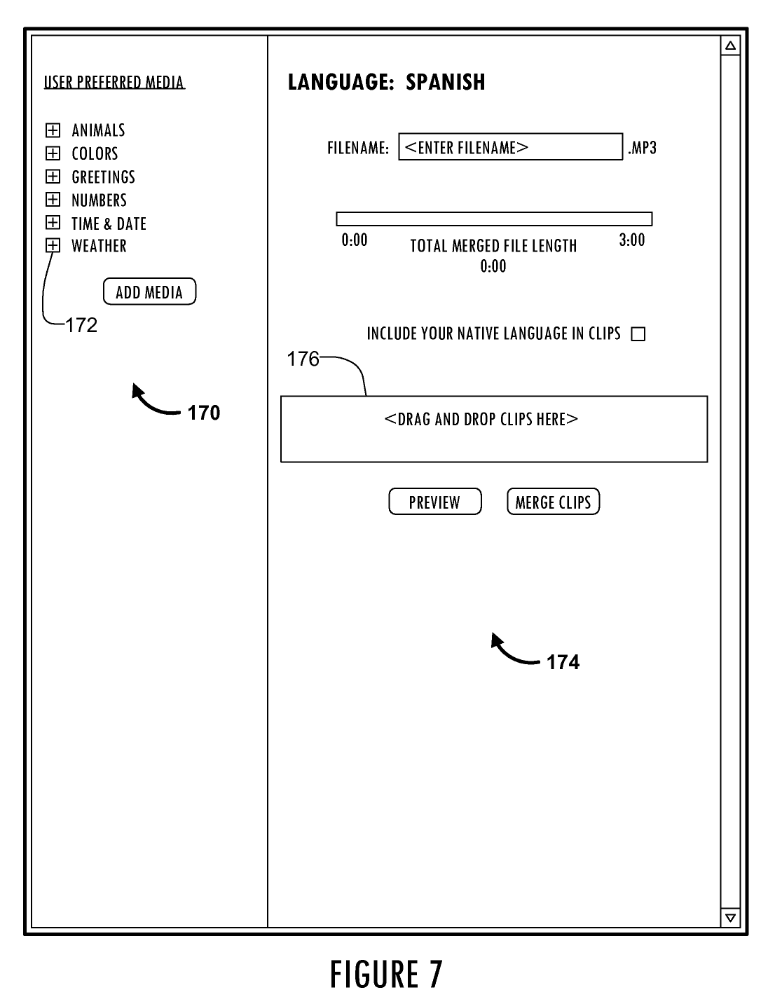

FIG. 7 is an exemplary layout of a GUI representing steps 110, 114, 116, 118, 120, 122, and 124 of FIG. 5. This is how a screen may look prior to any input by the user. The User Preferred Media preview area 170 contains categories similar to the Database Media Preview screen (FIG. 6). The categories are in the form of a collapsible tree layout. FIG. 7 depicts all categories in the collapsed state. Clicking an expansion icon 172 may expand each category.

A lesson customization area 174 may be provided to arrange preferred audio clips into a user-customized lesson sequence. This may be achieved by dragging clips from the preferred media area 170 and dropping them into a media arrangement window 176. While drag and drop methods are mentioned in the example, many GUI methods may prove satisfactory in arranging media.

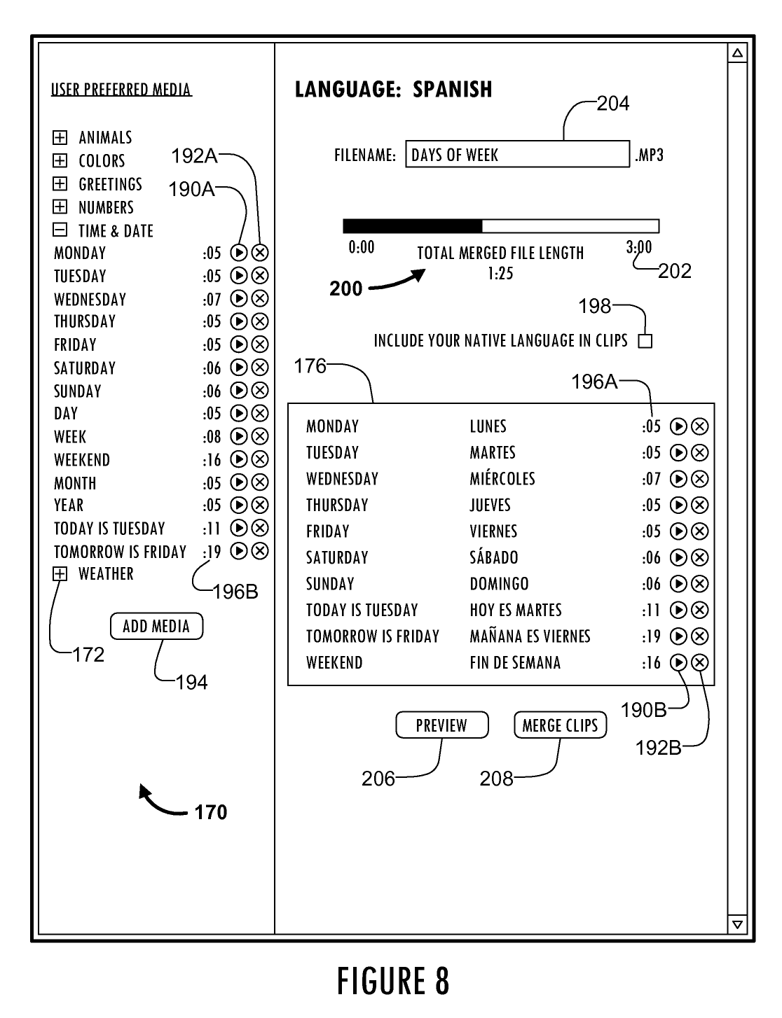

FIG. 8 is an exemplary screen layout similar to FIG. 7. However in FIG. 8, some settings have been input by the user. In this example the user has selected to work in the Time & Date category. The user has expanded a User Preferred Media category by clicking the appropriate expansion icon 172. User preferred media may be previewed by clicking a play button 190A. This may open a media player that is internal or external to the method. If the user decides the audio clip is no longer relevant to their lesson needs, a delete button 192A may be clicked. This action will remove the specific clip from the User Preferred Media area 170. However this will not delete the media clip from the media database 102.

If the user decides more media is required to achieve proper results, an “Add Media” button 194 is provided. Clicking the Add Media button 194 may take the user back to the media database preview screen (FIG. 6). From the media database preview screen the user may move additional media clips to the User Preferred Media area 170.

In this example, the user has dropped ten clips into the media arrangement window 176. For organizational purposes, a first column may indicate the native phrase and a second column may display its respective Spanish translation. A third column may display a media clip time duration 196A. An additional media clip time duration 196B may also be displayed in the User Preferred Media area 170.

Similar to the User Preferred Media area 170, the phrase media in the media arrangement window 176 may be previewed and deleted using an additional play button 190B and an additional delete button 192B.

A native language check box 198 may be provided to include phrases in the user's native language in the resultant merged media file. Simply merging the foreign phrases alone may not be beneficial to the user. If a user is unfamiliar with the foreign words, they may be meaningless without their English counterpart. Therefore, checking the native language check box 198 may include the English phrases as well as the Spanish Phrases. In the example of FIG. 8, merging the files without checking the native language check box 198 would render the following resultant media file:
Lunes, Martes, Miércoles, Jueves, Viernes, Sábado, Domingo, Hoy es martes, Mañana es viernes, Fin de semana.

Merging the same arrangement with the native language check box 198 checked, the resultant media file would be: Monday, Lunes, Tuesday, Martes, Wednesday, Miercoles, Thursday, Jueves, Friday, Viernes, Saturday, Sábado, Sunday, Domingo, Today is Tuesday, Hoy es martes, Tomorrow is Friday, Mañana es viernes, Weekend, Fin de semana.

This option may interleave the native audio with the foreign audio, giving the user some assistance as to the meaning of the foreign phrases.

A Total Merged File Length meter 200 may be provided to display the current time duration of the proposed merged media file. For practicality, a merged clip length limit 202 may be imposed. In this example, the system limit has been set at three minutes. With this restriction, the media clip time durations 196A and 196B may be useful to the user. Customized lesson creation strategies can be evaluated based on source media clip time durations 196A and 196B as well as the remaining free space in the merged file length meter 200. In the example of FIG. 8, the current merged file length is 1 m:25 s. There is 1 m:35 s of free space remaining. Media clip time durations 196B in the user preferred media area 170 may give the user an idea of what future media may fit in the proposed merged media file.

A file-naming field 204 may be provided to assign a unique filename to the resultant merged file. This may be required if multiple merged files are to be created and stored in the same location. While the example indicates the creation of an mp3 file, many types of media formats may be used in the method.

A preview button 206 may be provided to allow the user to preview their work done in the media arrangement window 176 without the process of destructive file merging. Alternatively, the preview button 206 may play the individual media clips directly from the media database 102 in a sequence obtained from the media arrangement window 176. Destructive media merging demands substantial resources from the hosting processor. At this point destructive merging may be avoided to preserve system resources, as the user simply wants to preview the work, not merge it for final output.

When the user finalizes the customized lesson sequence, a merge clips button 208 may be clicked to initiate the destructive clip merging process. In this example, the ten individual audio clips in the media arrangement window 176 will be combined into a single media file. As noted in the total merged file length meter 200, the resultant file will be 1 m:25 s in length. This is simply the sum of the individual media clip lengths 196A in the media arrangement window 176.

After the merging process, the resultant merged media file may be stored in a user-customized lesson storage location.

For the purposes of this disclosure, only one media arrangement window 176 is displayed. However, alternative GUI layouts may provide more than one media arrangement window 176. This may allow the user to customize multiple lessons in a single session. Clicking the merge clip button 208 may execute a batch merging process in which multiple customized media files are created.

Additionally, a plurality of languages may be used in the user-customized merging process. Thus, the GUI depicted in FIG. 8 may be modified to include a plurality of languages in the user preferred media area 170 and media arrangement window 176.

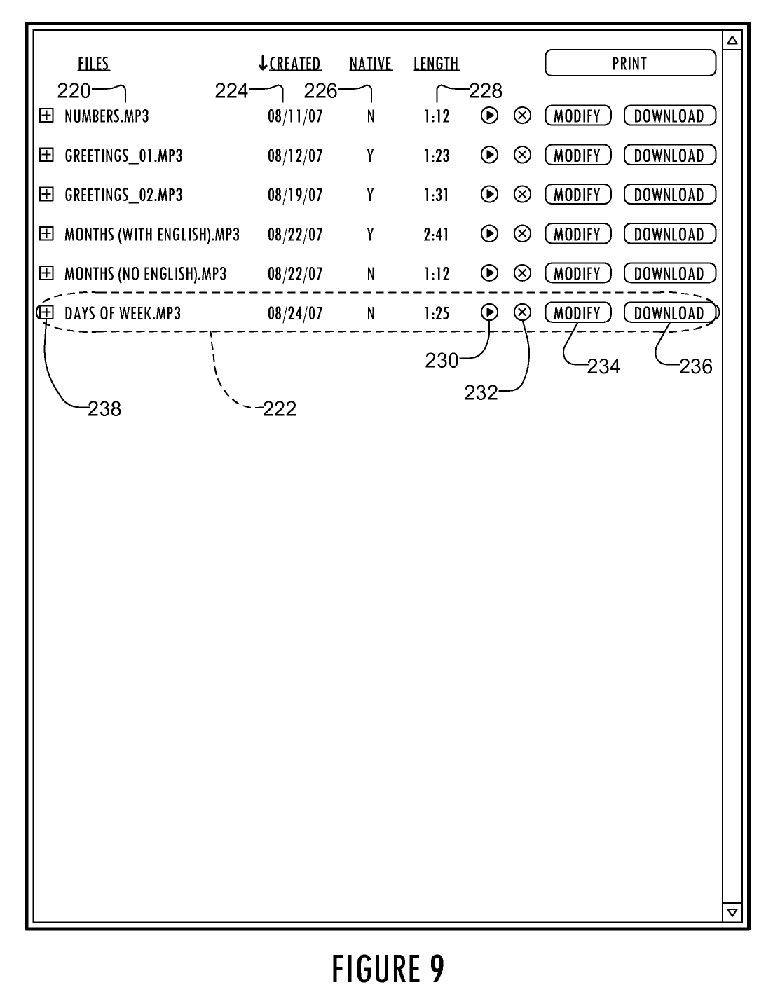

FIG. 9 is an exemplary screen layout for a user-customized lesson preview screen (Step 130 of FIG. 5). In the example, the user has created six customized media files. A file name column 220 may be displayed to identify the merged media files. In this example, the user-customized media files have the following names:

NUMBERS.MP3
GREETINGS_01.MP3
GREETINGS_02.MP3
MONTHS (WITH ENGLISH).MP3
MONTHS (NO ENGLISH).MP3
DAYS OF WEEK.MP3

A lesson file DAYS OF WEEK.MP3 222 was created in the exemplary process of FIG. 8. The filename DAYS OF WEEK.MP3 was input by the user in FIG. 8. A file creation date 224 may also be displayed to aid in identifying the customized lesson files.

If the native language check box 198 was checked in FIG. 8, the user-customized lesson preview screen may indicate this setting. A native column 226 may indicate Yes (Y) or No (N) as to whether or not the native language audio clips have been included in the merged file.

An audio file length column 228 may be displayed indicating the total time duration of the merged media clip. This value is the equivalent to the total merged file length meter 200 of FIG. 8 at the time of file merging.

A play button 230 and delete button 232 may be provided to preview and delete customized lessons as required. Clicking the play button 230 may open a media player that is internal or external to the method. If the user deems a customized lesson file no longer useful, they may click the delete button 232. This will remove the merged media file from the user-customized lesson storage location.

To modify a merged lesson file, the user may click a modify button 234. This may access the data log 126 and retrieve the ID list of source media files used to create the merged lesson file. The individual file IDs from the data log 126 may be used to place copies of the source media files from the database 102 back into the media arrangement window 176. This may bring the user back to the lesson customization screen where the merged media file sequence may be reworked.

A download button 236 may provide a way for the user to download the lesson media file 222. Clicking the download button 236 may move a copy of the merged media file 222 to the user's desktop, portable media player or any other location the user prefers.

An expand/collapse button 238 may be included to provide the user further details about the merged lesson file 222.

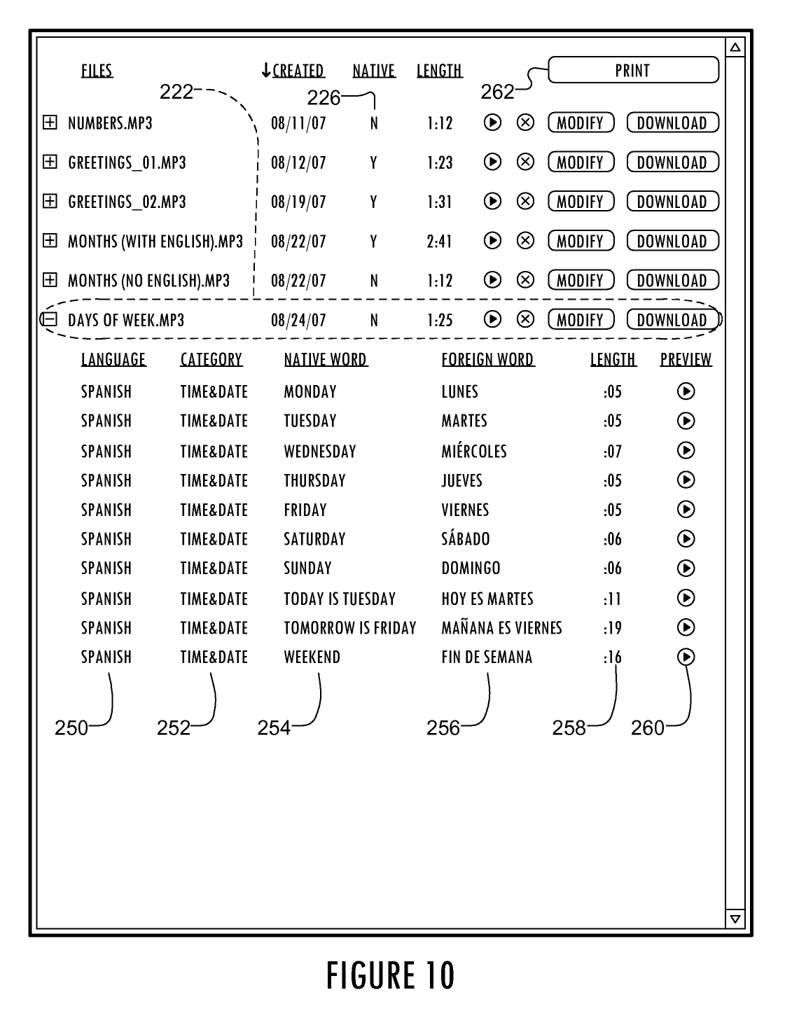

FIG. 10 is another exemplary layout of the user-customized lesson preview screen. In this figure the merged media file 222 is in an expanded state. The expanded state may provide additional details about the contents of the merged media file 222. There may be a language column 250 indicating the language of the source audio clip. In this example, all of the source audio clips are in Spanish. The language column 250 may be useful if a plurality of languages were included in the customized lesson file 222.

A category column 252 may also be included to provide further clarity as to the origin of a source media clip. In the present example, the user-customized media file 222 is comprised of source media clips from the Time & Date category. However, a plurality of categories in a plurality of languages may be included in a merged media file.

A native word column 254 and a foreign word column 256 are provided to identify the source media clips that make up the merged media file 222. Both native and foreign translations are provided to give the user an additional degree of clarity as to which clips are included. Although both native and foreign text is shown, both native and foreign audio may not be included in the resultant merged audio file 222. As mentioned before, the native language inclusion column 226 may identify this.

A media clip length column 258 may also be included for user convenience and additional situational awareness.

A play button 260 may be included to allow the user to preview the source audio clips of the user-customized lesson 222. This action may not access the imbedded audio of the merged media file 222. Alternatively, it may access the source media file information of the merged media file 222 located in the data log 126. The data log 126 may store the individual clip information of the merged media file 222. Using the source media clip identifiers, the system may retrieve the individual source audio from the database 102 and provide it for preview.

A print button 262 may be provided to create a printer-friendly transcript containing the individual source media clip information of the user-customized lesson 222. This may give the user a record of prior merged media clips. Additionally, reading the transcript while listening to the merged media file may improve the user's reading and writing skills.

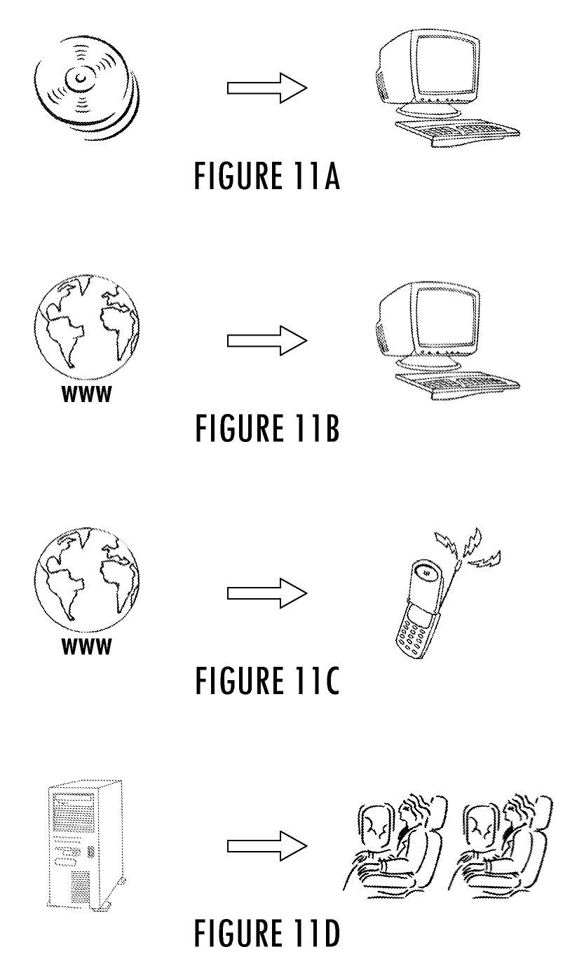

FIGS. 11A, 11B, 11C and 11D show four examples in which a customized lesson system may be deployed. FIG. 11A shows a complete system being distributed via CD or DVD (hereinafter CD). The CD's may contain all the code required for such a system as well as all of the rich media required. The software developer via Internet connection or additional CD distribution may provide media updates, corrections and additions.

FIG. 11B shows a system that may be hosted on a web server. Users may access the customized lesson system using their personal computer via a global network. All code and rich media may be provided on the hosting server or plurality of hosting servers. All media preview, sequencing and file merging may be done on the hosting server. User-customized merged media files may then be downloaded to the user's local machine.

FIG. 11C shows a system that may be hosted on a web server and accessed by users via mobile device. As mobile devices become more powerful and web enabled, users may access and use the customized lesson system from remote locations. Audio media may be delivered through a telephone earpiece or an onboard speaker. Still images or video media may be delivered through the unit's display screen.

FIG. 11D shows a system that may be hosted on a local area network (LAN) and distributed to multiple users. This implementation may vary widely. Some uses may be on airplanes, in classrooms or in offices. Additionally, a wide area network (WAN) may be used to provide the customized lesson system.

Although lesson customization methods described here pertain to the field of language learning, they may be used analogously in other applications. For example, in the field of math and science, a media database may contain equations, numerical constants, the periodic table of elements, theories, laws, and other information. A user may access the media database, select pertinent scientific information, arrange the pertinent media into a preferred lesson sequence and merge the media pieces into a customized science lesson.

As other alternatives, spelling practice and word definitions are among other uses for lesson customization methods. For a system providing spelling lessons, a media database may contain a plurality of media clips presenting words followed by their spelling. A user may browse the media database for words they are interested in spelling. They may select pertinent media clips, arrange them in a preferred sequence and merge the media clips into a single customized lesson. An exemplary customized spelling lesson is displayed below.

Tree . . . T-R-E-E . . . Cup . . . C-U-P . . . Glass . . . G-L-A-S-S

In the above example, the user was interested in learning how to spell tree, cup and glass. Thus, the user may have selected these words from a media database, where tree, cup and glass are all individual media clips. The user may then have arranged the clips into a preferred sequence and destructively merged them into the customized lesson depicted above.

For the example of word definition, a media database may contain a plurality of media files each containing a word followed by its definition. A user may browse the media database for definitions they are interested in learning. They may select pertinent media clips, arrange them in a preferred sequence and merge the media clips into a customized lesson. An exemplary customized definition lesson is displayed below.
CUSTOMIZED . . . Modified to suit a particular individual or task . . . LESSON . . . A period of learning or teaching . . . METHOD . . . a particular form or procedure for accomplishing something . . . PATENT . . . A government authority to an individual or organization conferring the right of title to make, use or sell some invention.

In the above example, the user was interested in learning the definition of the words CUSTOMIZED, LESSON, METHOD and PATENT. Thus, the user may have selected these definitions from a media database. The user may then have arranged the clips into a preferred sequence and destructively merged them into the customized lesson depicted above.

While the multimedia files in the exemplary embodiments are described as containing audio content along with text and other metadata, they may further include video content that correspond to the respective phrase segments. In addition to audio CDs, audio-visual DVDs may be created for the output lesson so that they can be played on a PC or even a TV. Further, the output audio-visual lesson file can be downloaded to a multimedia-capable mobile device, such as an iPod device as offered by Apple Computer Corp.

### ADVANTAGES OF THE INVENTION

The lesson customization methods of this invention can thus be used to create user-selected and learning-efficient lesson plans. The efficiency is linked to the user's ability to select pertinent lesson media and arrange the media into a preferred sequence. Further, the destructive file merging capability has additional advantages as it eliminates the large number of media clips, required for such a customized lesson, from the user's drive. This may increase file organization and overall system performance on the user's machine.

The user-customized lesson method provides several advantages over prior learning methods. For example, a user can focus on a specific area of vocabulary building. By creating a user-customized lesson using the database driven system, the user can select certain vocabulary phrases that are useful. Further, the user may sort the individual phrases into a preferred sequence that suits their requirements. This allows the user to learn exactly what they want, when they want to. It eliminates the burden and wasted time of material that is not needed.

The invention method facilitates and adds convenience to language learning on audio CD. Since the user can customize their own lesson, hunting for lesson segments of interest or distractions while fast-forwarding or rewinding can be avoided. The user-selected phrases have been arranged into a preferred sequence and merged into a customized lesson. By creating user-customized lessons using the database driven system, the user can create a lesson made up solely of the phrases they are interested in learning. This will allow the user to focus on specific vocabulary until it is placed into their long-term memory.

Another advantage of the user-customized lesson method is the ability to print transcripts of the customized media lesson. The user can print a text version of all phrases in the lesson from the data log created during the merging of media files. This will allow the user to read along as they are listening to the media. This is especially helpful in increasing reading and writing skills. It creates an association between the spoken word and written word.

While a number of embodiments of the invention have been described, it is to be understood that various modifications may be made without departing from the spirit and scope of the invention. For example, various forms of the flows shown above may be used, with steps re-ordered, added, or removed. Also, although several applications of the customized lesson system have been described, it should be recognized that numerous other applications are contemplated. Accordingly, other embodiments are within the scope of the following claims.

1. A method for creating a user-customized multimedia-based instructional lesson adapted for playback on a user playback device, comprising:
providing access to a plurality of lesson segments that are retrieved or generated as media files from a storage medium;
providing a user interface for enabling user selection of desired lesson segments from the retrieved or generated media files for a customized instructional lesson, and for enabling user ordering of the selected lesson segments into a customized lesson sequence; and
providing a file conversion function for integrating the media files for the selected lesson segments into an instructional lesson media file.

2. A method for creating a user-customized multimedia-based instructional lesson according to claim 1, wherein the lesson segments are phrase segments for learning phrases of a foreign language maintained in an associated database.

3. A method for creating a user-customized multimedia-based instructional lesson according to claim 2, wherein the lesson segments are phrase segments of a plurality of foreign languages maintained in the database.

4. A method for creating a user-customized multimedia-based instructional lesson according to claim 2, wherein the step of providing a user interface includes the interface enabling a user to browse for phrase segments and select what is of interest.

5. A method for creating a user-customized multimedia-based instructional lesson according to claim 2, wherein the file conversion function destructively merges the media files into a single instructional lesson media file.

6. A method for creating a user-customized multimedia-based instructional lesson according to claim 1, further including the step of providing access for user download of the instructional lesson media file as an output to a user device.

7. A method for creating a user-customized multimedia-based instructional lesson according to claim 1, further including the step of providing access for user download of the instructional lesson media file as an output to a media player.

8. A method for creating a user-customized multimedia-based instructional lesson according to claim 1, further including the step of providing access for user download of the instructional lesson media file as an output to a mobile player device.

9. A method for creating a user-customized multimedia-based instructional lesson according to claim 5, wherein during the destructive merging of the media files, metadata associated with the individual media files are stored in a data log for user access such as to print a text transcript of the customized instructional lesson.

10. A method for creating a user-customized multimedia-based instructional lesson according to claim 5, wherein the lesson segments are stored as audio files in the database in compressed format to preserve storage space, and the destructive merging step includes converting selected audio files into uncompressed audio format so that they can be merged into a single lesson audio file.

11. A computerized system for creating a user-customized multimedia-based instructional lesson adapted for playback on a user playback device, comprising:
a storage medium for enabling the retrieval or generation of a plurality of lesson segments as media files;
a user interface having a first component for enabling user selection of desired lesson segments retrieved or generated from the storage medium for a customized instructional lesson, and a second component for enabling user ordering of the selected lesson segments into a customized lesson sequence; and
said computer system having a file conversion function for integrating the media files for selected lesson segments into an instructional lesson media file as an output.

12. A computerized system for creating a user-customized multimedia-based instructional lesson according to claim 11, wherein the lesson segments are phrase segments for learning phrases of a foreign language maintained in an associated database.

13. A computerized system for creating a user-customized multimedia-based instructional lesson according to claim 12, wherein the lesson segments are phrase segments of a plurality of foreign languages maintained in the database.

14. A computerized system for creating a user-customized multimedia-based instructional lesson according to claim 12, wherein said user interface includes an interface component for enabling a user to browse for phrase segments and select what is of interest.

15. A computerized system for creating a user-customized multimedia-based instructional lesson according to claim 12, wherein the file conversion function destructively merges the media files into a single instructional lesson media file.

16. A computerized system for creating a user-customized multimedia-based instructional lesson according to claim 11, further including an output component for enabling user download of the instructional lesson media file as an output to a user device.

17. A computerized system for creating a user-customized multimedia-based instructional lesson according to claim 11, further including an output component for enabling user download of the instructional lesson media file as an output to a media player.

18. A computerized system for creating a user-customized multimedia-based instructional lesson according to claim 11, further including an output component for enabling user download of the instructional lesson media file as an output to a mobile player device.

19. A computerized system for creating a user-customized multimedia-based instructional lesson according to claim 15, wherein during the destructive merging of the media files, metadata associated with the individual media files are stored in a data log for user access such as to print a text transcript of the customized instructional lesson.

20. A computerized system for creating a user-customized multimedia-based instructional lesson according to claim 11, wherein the lesson segments are stored as audio files in the database in compressed format to preserve storage space, and the destructive merging step includes converting selected audio files into uncompressed audio format so that they can be merged into a single lesson audio file.

21. A method for creating a user-customized multimedia-based instructional lesson according to claim 1, wherein the media files for the lesson segments are audio files generated from lesson text using stored software-based text-to-speech generators.

22. A computerized system for creating a user-customized multimedia-based instructional lesson according to claim 11, wherein the storage medium stores software-based text-to-speech generators, and the user interface is adapted to enable a user to select lesson text for generating audio files from the text-to-speech generators as the media files for the lesson segments.
